(19) United States
(12) Patent Application Publication
(10) Pub. No.: US 2011/0271647 A1
(43) Pub. Date: Nov. 10, 2011

(54) HAYBALE-LIFTER SPEAR ATTACHMENT

(75) Inventor: Paul Horst, (US)

(73) Assignee: TUBE-LINE MANUFACTURING LTD., Elmira (CA)

(21) Appl. No.: 13/101,514

(22) Filed: May 5, 2011

(30) Foreign Application Priority Data
May 6, 2010 (GB) GB-1007596.8

(51) Int. Cl. A01D 90/02; B65B 11/00

(52) U.S. Cl. 53/461; 414/24.5; 414/800

(57) ABSTRACT

For use with a hay wagon that has a lifting-cradle for picking up haybales from a field and depositing the bales on the platform of the wagon, ready for transport to a bale-wrapping machine. A bale-lifting-spear is mounted on the cradle. The first and last bales of a sausage have to be bagged; the spear, in conjunction with the cradle and its lifting mechanism, is used to lift the first and last bales off the ground, and thereby to enable a plastic bag to be placed over the bale.

This technology relates to hay bales, and to the operation of wrapping the bales into a long continuous airtight sausage of bales. More particularly, the technology relates to the manner in which the two ends of the sausage are made airtight.

A well-favoured and efficient way of storing hay is to enclose a rolled and bound haybale in an airtight and watertight plastic wrapping. Thus stored, soluble and volatile nutrients in the hay are preserved, and silage-like fermentation can take place.

In continuous plastic wrapping, the bales are placed end to end, in touching contact, and the several bales are wrapped circumferentially—that is to say, helically—to form a single long sausage. The wrapped sausage may contain, say, a hundred bales. The wrapped sausage comes off the wrapping machine continuously and progressively, and the sausage is laid down in the field right where it is wrapped. It may be regarded that moving the sausage, once it is wrapped, is all but impossible.

The bales in the sausage may be round, i.e cylindrical, or rectanguloid.

The bales are formed by a baling machine, or baler, which packs the strands of hay tightly and solidly together. A round-baler rolls the hay into a cylinder. The shape of the now-formed bale is maintained in that the baler binds the formed bale with e.g twine or plastic netting. The netted-bale is then deposited, on the ground, by the baler. (The expression “netted-bale”, herein, is a bale that has been tied or bound in such manner as to maintain the formed shape of the bale.)

The baling-machine is mobile, being self-propelled or towed by a tractor. Typically, the baling-machine deposits the netted-bale in the field, and then moves on to roll and bind the next bale. After baling, therefore, the netted-bales are left dotted or scattered over the hay-field, more or less randomly.

In continuous wrapping, it is necessary to pick up each netted-bale from the field, and to transport the netted-bale to the continuous-wrapping-machine. The continuous-wrapping-machine is not stationary, in that it moves forwards progressively, slowly, as the sausage is created. The continuous-wrapping-machine must follow a fixed path, as dictated by the ever-lengthening sausage. The bound-haybales must be transported from where they were dropped in the field, over to the continuous-wrapping machine.

Therefore, the task arises, of transporting the netted-bales over to the continuous-wrapping-machine. This is done, basically, by picking up and loading the netted-bales onto a trailer or wagon, and then driving the wagon over to the continuous-wrapping-machine.

A well-favoured design of implement for collecting and transporting haybales is an implement herein called a tech-wagon. For present purposes, a tech-wagon is an implement that combines a bale-cradle, which is configured for picking up a (netted) haybale resting on the ground, and for lifting the bale onto the platform of the tech-wagon. Typically, the tech-wagon has a capacity of e.g six or eight bales. The tech-wagon is towed by a tractor, or it may be self propelled. The tech-wagon includes a lifting mechanism for operating the cradle, and for lifting the bale onto the platform. The cradle-lifter typically is powered hydraulically, e.g using the hydraulic pumps and controls located on the wagon-tractor.

An example of a tech-wagon may be seen at www.tubeline.ca/Products/Technobale.

Absent the use of a tech-wagon, netted-bales can be picked up by the use of a tractor or front-end-loader equipped with a bale-spear, which is used to pick up the bales, and to place them on a wagon or trailer. Often, two operators are needed—one to drive the tractor with the bale-spear, and another operator to drive the tractor pulling the wagon.

In the two-tractor system, during collection, the two tractors drive around the field. The two stop at a netted-bale, where the spear-tractor picks up the bale and deposits it in the wagon. Then, both the spear-tractor and the wagon-tractor drive on to the next netted-bale. After collecting e.g six bales onto the wagon, the wagon-tractor then drives over to the location where the bale-wrapping operation is slated to take place, and deposits the six netted-bales on the ground.

Using this two-tractor system for collecting and moving the netted-bales, the bales could be delivered at the typical rate of about twenty-five bales per hour.

A modern continuous-bale-wrapping-machine, by contrast, can wrap netted-bales into a continuous sausage at the rate of about a hundred bales per hour. Thus, the wrapping-machine can receive and process the netted-bales at typically four times the speed at which the two-tractor bale-collection system can deliver the netted-bales to the wrapping-machine.

This disparity between the rate at which the netted-bales were delivered and the rate at which the bales were wrapped, dictated the manner in which the task of collecting and wrapping the bales was carried out. The collecting/delivery being considerably slower than the wrapping, the task naturally divided itself into two quite separate elements. First, the bales were collected and transported—at twenty-five bales per hour—to the corner of the field in which the sausage was to be laid down. The bales were arranged, there, in a line, whereby each bale was handily placed for—in due course—being fed into the wrapping-machine. Then, on a separate future occasion (say, the next day), the wrapping operation was carried out; the netted-bales, being now handily placed, could now be loaded onto the deck of the wrapping-machine quickly enough to keep pace with the wrapping operation.

With the advent of the tech-wagon design, the netted-bales can now be picked up and delivered to the continuous-wrapping-machine as rapidly as the wrapping-machine can wrap them—being a rate, typically, of a hundred bales per hour.

Therefore, the whole overall operation of collecting and wrapping the bales can be done as one operation, using only two tractors. Using the tech-wagon, the netted-bales are collected from the field and delivered directly onto the receiving-deck of the continuous-wrapping-machine, ready to be wrapped immediately. There is no need for the bales to be stored temporarily in a corner of the field. In fact, there is no need for the netted-bales to be placed on the ground at all, once having been picked up and placed on the platform of the tech-wagon. The bales are simply delivered directly to the receiving-deck of the wrapping-machine. This being so, the whole combined task of picking up the netted-bales dotted around the field (i.e from where they were deposited by the baler) and wrapping the bales into the long sausage, is done very efficiently indeed.

In fact, now that the whole task can be done so very efficiently, some aspects of the overall operation that were formerly regarded as merely minor delays, now come to be regarded as major obstacles to efficiency, and it is with such a delay that the present technology is concerned.

It is desirable that the first and last bales of the sausage should be protected, at their respective outer ends, from the elements. The other bales in the sausage are tightly encased inside the plastic winding, whereby all the nutrients in the hay are retained, and whereby the desired fermentation reactions can take place, over the required period of time. If the ends of the first and last bales are left exposed, those end bales can become spoiled—and some of the adjacent bales can be spoiled, too.

One way in which the ends of the first and last bales have been protected is by the use of plastic bags.

The bag is placed over one end of the netted-bale, prior to the bale being wrapped. However, placing the plastic bag in position, on the bale, has been a difficult task. One procedure that has been used is that in that the bale is wrapped partially, prior to the bag being applied; then, the wrapping-machine is stopped, and the operator works the skirt of the bag under the last turn of the plastic wrapping. When that is done, the wrapping-machine is restarted, and the wrapping operation is finished, whereby the bag is now held securely by the wrapping.

This tucking-in-the-skirt manner of securing the bag has been effective to seal the first and last bales of the sausage, when done properly, but it is inevitably quite time-consuming. Also, it can be dangerous, in that the operator has to rotate the bale, while he is in close proximity to it, in order that the skirt of the bag can be tucked under the plastic, right around the bale.

Thus, placing the plastic bags over the first and last netted-bales, prior to wrapping, is, in fact, a rather complex and time-consuming operation, and is far from being the trivial task that it might, at first, appear.

In the tech-wagon design, the bale is lifted by a cradle, rather than by a spear. A bale-lifting cradle is preferred, for this purpose, over e.g a bale-lifting spear, for the following reasons.

In the tech-wagon, when the cradle approaches the netted-bale, lying on its side on the ground, the cylindrical axis of the bale might not be aligned with the direction from which the tractor-drawn tech-wagon approaches the bale. At worst, the direction of travel of the tech-wagon would be at right-angles to the axis of the bale. When the bale-lifter is a spear, the tractor must be driven with the axis of the spear co-axial (or nearly coaxial) with the axis of the bale. On the other hand, when the bale is to be lifted by a cradle, the cradle can be provided with a deflector, which can rotate the netted-bale as the bale enters the cradle, to ensure proper alignment.

However, one disadvantage of basing the design of the bale-lifter on a cradle is that, when the netted-bale is resting on the cradle, the plastic bag cannot easily be assembled onto the bale. In order to enable the task of placing the bag on the bale, the bale has to be raised off the ground, giving access preferably to the whole of the (cylindrical) surface of the (round) bale. This is the kind of access that is present when the bale is lifted by means of a spear, which engages the bale only from its end-face. Only then can the plastic bag very easily be slipped over the end of the bale.

When using the tech-wagon, with its hugely efficient manner of picking up haybales and conveying them to the bale-wrapping machine, the inefficiencies associated with putting a plastic bag on the (two) end-bales become highly visible, and troublesome. The two end bales have to be picked up by a front-end-loader, equipped with a bale-spear, just for the single purpose of lifting the first and last bales off the ground, and enabling a plastic bag to be slipped over the bale. In the case of a hundred-bale sausage, the other ninety-eight bales are handled entirely by the tech-wagon.

Done this way, the apparently-simple task of putting the bags on the first and last bales, in the context of a real-life practical farm operation, can actually double the aggregate time it takes to collect the netted-bales from the field and form them into a long wrapped sausage. That is to say: by the use of the cradle-type tech-wagon, the task of collecting e.g a hundred netted-bales from a field, and forming those bales into a long wrapped sausage, can (at least notionally) be done in about an hour. The task of wrapping the first and last bales, done in the traditional manner, can very easily add another hour to that time.

It is recognized that the task of bagging the first and last bales can be rendered trivial, taking almost no time at all, by making a simple modification to the cradle of the cradle-type bale-lifter. That modification is to add a spear to the cradle.

The cradle-mounted spear should be retractable. That is to say, the spear should be mounted, on the cradle, in such manner that the spear can easily be made ready for use (deployed), and can easily be tucked out of the way when not in use (retracted, or stowed).

The deployment and retraction of the spear can be done manually (which requires the driver to get down from the tractor), or can be power-assisted (whereby the driver can deploy and retract the spear from the cab of the tractor).

Of course, the driver has to get down from the cab, in any event, in order to slip the plastic bags over the first and last bales; but if the deployment and retraction of the spear can be operable in response to e.g a hydraulic or electrical control in the cab of the tractor, at least one getting-down episode can be eliminated, and some time can be saved.

When the spear is deployed, it should point forwards, i.e in the direction in which the tractor is pulling the tech-wagon. The forwards motion of the tech-wagon can then be utilized to drive the spear into the end of the netted-bale. Alternatively, the spear, when deployed, may point backwards, and the tech-wagon is then driven backwards towards the haybale, to drive the spear into the bale.

Generally, the first bagged bale is the first to be picked up, and placed on the platform, and the last bagged bale is the last to be picked up and placed on the platform. Of course, once assembled into the sausage, the respective bagged ends of the first and last bales have to face in opposite directions relative to the sausage, and relative to the platform of the tech-wagon. It is up to the driver of the wagon-tractor to handle the first and last bales in such manner as to make this so.

Preferably, the netted-bales should be stacked on the platform so they can be transferred from the back-end of the platform of the tech-wagon directly onto the loading deck of the continuous-wrapping-machine. But however the bales are to be moved from the platform to the wrapping machine, of course the first-bagged-bale should be so loaded and arranged, on the platform, that it is the first bale to be wrapped, and so that its bagged end is the first end to be wrapped, of the first bale. Equally, the last-bagged-bale should be so loaded and arranged, on the platform, that it is the last bale to be wrapped, and so that its bagged end is the last end of the last bale to be wrapped.

The netted-bales are picked up from the field, by the cradle, and are loaded onto the platform of the tech-wagon, in batches of six, eight, etc, depending on the capacity of the platform. It may be noted that all six (eight, etc) of the bales are picked up and placed on the platform while the tech-wagon is in motion, i.e is being driven around the field, picking up the netted-bales.

The batch of bales having been collected, the tech-wagon is then driven over to the bale-wrapping-machine. There, the wagon-tractor driver reverses the tech-wagon against the wrapping-machine, in such manner that the back-end of the tech-wagon contacts the front end of the loading-deck of the wrapping machine. Thereupon, a connection is made (e.g automatically) between a plug located at the back end of the tech-wagon and a receptacle on the front end of the deck of the wrapping-machine.

The connection preferably includes a hydraulic coupling, whereby the hydraulic pumps and controls of the wagon-tractor can be utilized for the task of effecting the transfer of the batch of bales. Hydraulically-powered bale-movers or conveyors may be provided in the platform, and in the deck, whereby—the connection having been made—the wagon-driver can quickly transfer the bales from the platform of the tech-wagon to the deck of the bale-wrapper.

### LIST OF THE DRAWINGS

In the accompanying drawings:

FIG. I is a plan view of an agricultural implement, being an example of a tech-wagon, as defined herein.

FIG. 2 is a side-elevation of the tech-wagon of FIG. 1

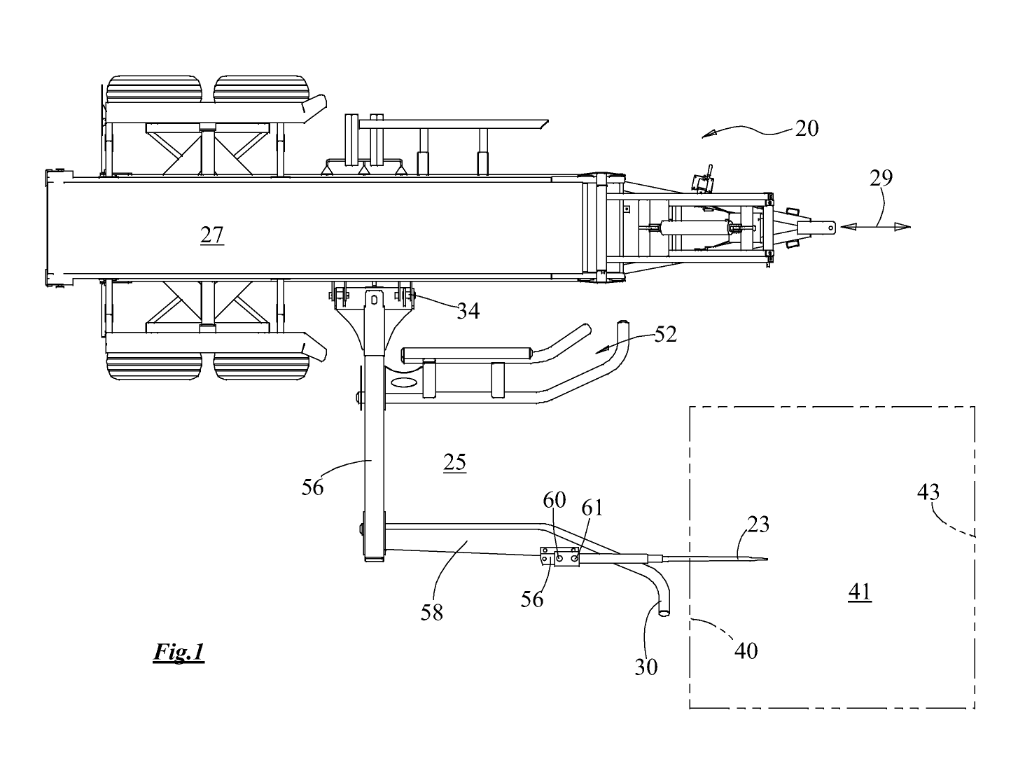

FIG. 3 is a pictorial view of a bale-cradle component of the tech-wagon, to which a bale-lifting spear has been attached.

FIG. 4 is the same view as FIG. 3, but shows another spear.

FIG. 5 is a plan view of the cradle of FIG. 4.

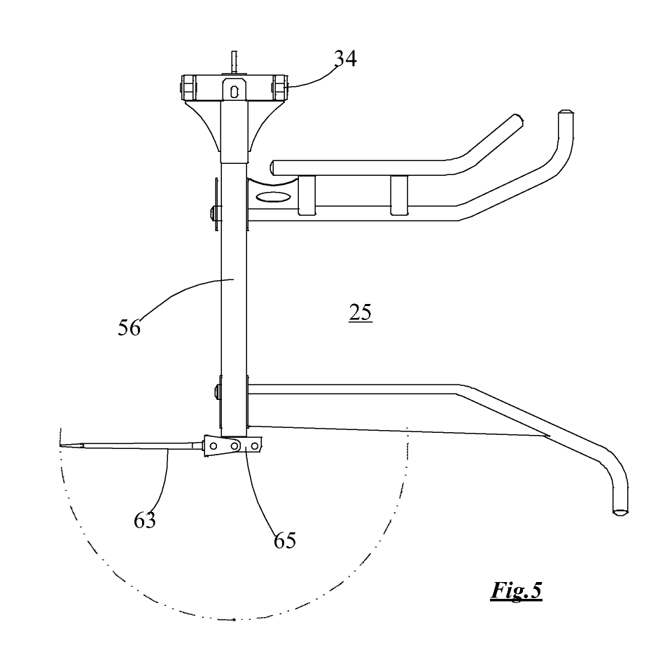

### DETAILED DESCRIPTION OF PREFERRED EMBODIMENTS

The technology will now be further described with reference to the accompanying drawings.

The tech-wagon 20 of FIG. I is adapted to be drawn by a tractor, termed the wagon-tractor. The wagon-tractor is coupled to the front end of the tech-wagon 20, being the right end in FIG. I.

The spear 23 is attached to the bale-cradle 25 of the tech-wagon 20 in such manner that the spear 23 points forwards, ahead of the cradle.

The traditional function of the tech-wagon 20, without the use of the spear 23, will first be described. This function includes collecting netted haybales in the cradle 25, and lifting the netted-bales onto the trailer-platform 27 of the tech-wagon.

The netted-bales to be lifted on to the platform 27 of the tech-wagon 20 are dotted around a field. The driver drives the wagon-tractor so that the cradle 25 of the bale-lifter 29 of the tech-wagon 20 is aligned with the next bale to be collected.

The tech-wagon 20 has been designed to carry the netted-bales with their cylindrical axes parallel to the longitudinal axis of the tech-wagon, i.e parallel to the direction of travel 29 of the wagon-tractor and tech-wagon 20. Now, it might happen that the netted-bale on the ground is not oriented such that its axis is lying parallel to that direction of travel. The cradle 25 is structured to change the orientation of the bale, in that the cradle is provided with a lead-in deflector 30. If the bale is mis-oriented, relative to the on-coming tech-wagon, one side of the bale strikes the lead-in deflector 30, causing the bale to turn and rotate, on the ground, until its axis is parallel to the direction of motion 29 of the cradle. Then, the cradle 25 slides under the bale. This re-orientation of the bale (if needed) takes place very quickly, and while the tech-wagon 20 is in motion.

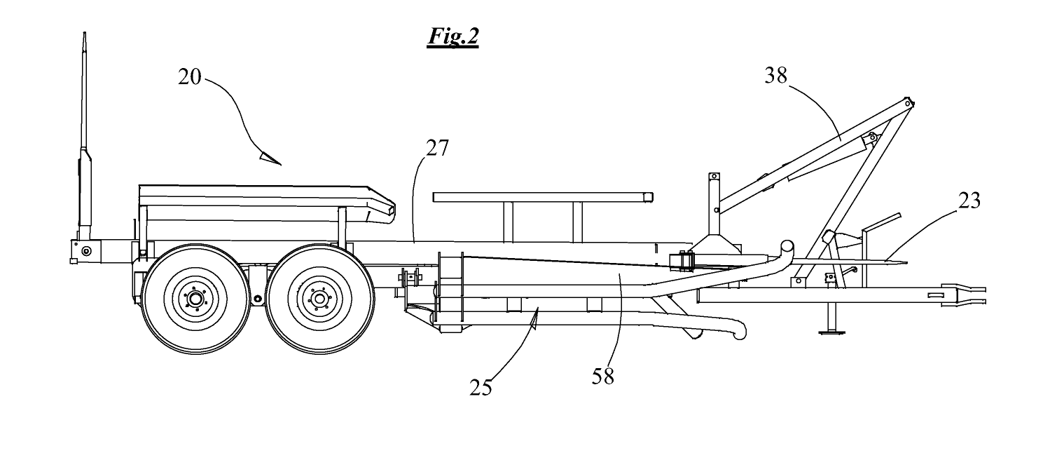

Once the bale is residing on the cradle, the driver operates the controls to rotate the bale-cradle 25 about its cradle-pivot 34. A cradle-lifter of the apparatus takes the form of a bracket 32 (see FIG. 3), which is operated by a hydraulic ram 35. When so operated, the bale-cradle rotates about the cradle-pivot 34, thereby raising the haybale off the ground. The cradle 25 is raised, lifting the haybale up and towards the platform 27 of the tech-wagon 20. The rising cradle 25 tips the bale onto the platform 27. The driver then reverses the operation of the bale-lifter, whereby the now-empty bale-cradle 25 returns to ground level, and is now ready to collect the next netted-bale.

It only takes a few seconds for a netted-bale to be oriented, cradled, lifted, and deposited onto the platform 27, and for the cradle 25 then to be returned to ground level. The operation can be completed while the tech-wagon 20 is moving, and is being drawn (by the wagon-tractor) along to the next netted-bale. It is emphasized that the tech-wagon 20 is (or can be) constantly in motion, driving around the field, picking up netted-bales.

The tech-wagon 20 is fitted with an operable bale-pusher 38. When the bale has been deposited on the platform 27, at the front of the tech-wagon, the driver operates the bale-pusher 38, which moves the bale to the back of the platform.

The driver loads netted-bales onto the platform 27, up to the capacity of the tech-wagon. The driver drives the tech-wagon, now with its batch of bales, over to the continuous-wrapping-machine, where the batch of bales is deposited directly onto the loading deck of the wrapping-machine. Then, the driver drives the empty tech-wagon 20 back across, or to, the field, ready to collect another batch of bales.

The operation of the spear 23, to enable the first and last of the netted-bales to be bagged, will now be described.

The first-bagged-bale should, of course, be so placed on the platform 27 that, when the batch of bales is delivered to the wrapping machine, the first-bagged-bale is so placed as to be the first bale to pass through the wrapping machine—and its orientation on the platform should be such that the bagged-end of the first-bagged-bale is the first end of the bale to be wrapped. The driver sees to it that the first-bagged-bale is properly placed, in terms of manoeuvring the tech-wagon, and which end of the bale should be the bagged-end, to ensure this proper presentation.

The driver deploys the spear 23, and locks the spear in the deployed, pointing-forwards, configuration. (Alternatively, the deployed configuration of the spear can be pointing-backwards. In that case, the tech-wagon would be driven in reverse in order to snag the spear into the end of the bale.)

The procedure for bagging and collecting the first bale of the sausage is described as follows.
[a] The (empty) tech-wagon 20, towed by the wagon-tractor, approaches the first netted-bale, which is resting on the ground in the field with its axis horizontal. (This is the bale that will become the first end-bale of the sausage.)
[b] The tech-wagon-tractor driver gets down from the wagon-tractor, and deploys the bale-lifting spear 23, which is mounted on the cradle 25 of the tech-wagon.
[c] Resuming his seat, the wagon-tractor driver drives the tech-wagon in such manner that the spear enters the spear-end-face 40 of the first netted-bale 41.
[d] From his seat, the tech-wagon driver activates the ram 35 of the bale-lifter, causing the spear 23 to rise, thus lifting the first netted-bale 41 off the ground.
[e] The driver gets down, and places the open-ended plastic bag over the accessible open-end-face 43 (at the non-speared end) of the first netted-bale 41. Now, this first netted-bale becomes the first bagged end-bale.
[f] Resuming his seat, the tech-wagon driver lowers the cradle 25, and spear 23, until the first bagged end-bale once more rests on the ground.
[g] The wagon driver so drives the wagon-tractor and tech-wagon as to withdraw the spear from the haybale 41.
[h] The wagon-driver gets down, and stows the spear 23.
[i] Resuming his seat, the driver drives the tech-wagon around the first bagged end-bale, now lying on the ground, so as to approach the first bagged end-bale from its bagged end. The wagon-tractor driver manoeuvres the tech-wagon 20 such that the cradle 25 picks up the first bagged end-bale 41, so approached. This is done while the tech-wagon is moving.
[j] From his seat, the wagon-driver operates the cradle-lifter to lift the first bagged end-bale onto the platform 27 of the tech-wagon. Again, this operation is done while the tech-wagon continues moving.

It will be understood, regarding step [b] above, that the spear may be locked in its deployed position at any time prior to picking up the first bale. However, preferably, the spear should be left safely stowed away until actually needed. Similarly, regarding step [h], the spear should be re-stowed soon after the spear has been withdrawn from the now-bagged end-bale.

Also, the tractor-driver might prefer to bag both the first bale and the last bale at the same time—or rather, as immediately-consecutive operations. The last bagged end-bale would then be left in the field, to be picked up later as a member of the last-batch of bales.

The above procedure assumes manual deployment and stowage of the bale-lifting spear. Optionally, the spear can be moved between its deployed and stowed positions using e.g hydraulic controls on the wagon-tractor, and the same applies to locking and unlocking the spear in and from those positions. However, the operations of deploying and stowing the spear, when done manually, can be done quickly and easily, thus making automation of these steps barely worthwhile.

The procedure for assembling and transferring the first-batch of haybales onto the deck of the wrapping-machine is described as follows. (The first-batch is that wagon-batch of bales that includes the first bagged end-bale.)
[a] When the platform 27 of the tech-wagon 20 is full, and contains the first-batch of haybales (comprising the first bagged end-bale plus e.g five unbagged bales), the driver drives the tech-wagon over to the bale-wrapping machine.
[b] From his seat, the wagon-driver backs the tech-wagon towards the bale-wrapping machine, whereby a nose on the back of the platform of the tech-wagon enters a socket on the deck of the bale-wrapper, and the tech-wagon automatically latches onto the bale-wrapper.
[c] The wagon-driver (or the wrapper-operator) then operates the machinery to transfer the first-batch of netted bales from the platform onto the deck of the bale-wrapper.

Once the first-batch of haybales has been transferred to the deck of the wrapping-machine, the wagon-tractor driver drives the tech-wagon 20 around the field, picking up the netted bales, and lifting them onto the platform 27 of the tech-wagon. These bales are destined to become the intermediate bales along the length of the sausage, and none of these need be bagged, prior to wrapping. Each haybale is picked up in the cradle 25 of the tech-wagon 20, and lifted up and deposited onto the platform 27 of the tech-wagon, without the driver leaving his seat in the wagon-tractor, indeed while the wagon-tractor is in continuous motion.

The procedure for bagging and collecting the last bale of the sausage is described as follows.
[a] The tech-wagon approaches a haybale that is resting in the field, with its axis horizontal, which is to do duty as the last bagged end-bale.
[b] The driver gets down, and deploys the spear.
[c] Resuming his seat, the driver manoeuvres the tech-wagon so the spear enters one of the end-faces of the netted-bale.
[d] From his seat, the driver so operates the bale-lifter as to raise the spear, thus lifting the netted-bale off the ground.
[e] The driver gets down, and places the open-ended plastic bag over the accessible end of the netted-bale. Now, the netted-bale becomes a bagged end-bale—in fact, it becomes the last bagged end-bale. The last bagged end-bale has a bagged-end and a non-bagged- or open-end.
[f] Resuming his seat, the driver lowers the spear until the last bagged end-bale rests on the ground.
[g] The driver so manoeuvres the tech-wagon as to withdraw the spear from the last bagged end-bale.
[h] The driver gets down, and stows the spear.
[i] Resuming his seat, the driver so moves the tech-wagon as to approach the last bagged end-bale from its non-bagged- or open-end. The driver manoeuvres the tech-wagon so the cradle picks up the last bagged end-bale, so approached.
[j] From his seat, the driver operates the cradle to lift the last bagged end-bale onto the platform of the tech-wagon.
[k] The driver transfers the last-batch of bales, being the batch of bales that includes the last bagged end-bale, to the bale-wrapping machine.

The bale-wrapping machine should have its own operator. It will be noted that, with the apparatuses and procedures as described herein, the wagon-driver (i.e the wagon-tractor driver) is occupied more or less full-time, and the bale-wrapper operator is occupied more or less full-time, during the whole operation of collecting the bales from the field and wrapping them into a sausage. The technology is such that, the rates of working of the two machines+operators can very easily be made to coincide, whereby it is possible for them to work efficiently together, in that neither need keep the other waiting.

Using the technology described herein, employing a bale-wrapping machine with its operator and a spear-equipped wagon-plus-tractor with its driver, it is possible for a hundred haybales to be collected from the field and wrapped into a both-ends-bagged sausage in a little over one hour, start to finish.

It can be seen from the drawings that adding a spear to a cradle-type bale-lifter can very easily be put into practical effect (once the suggestion has been made to do so). However, prior to this addition, simple though that may be, the tradition was to provide a separate spear-type bale-lifter—being, usually, a front loader with spear attached—just for the task of raising the first and last bales off the ground, to enable plastic bags to be slipped over them. It is recognized that the cradle-type bale-lifter that is already provided on the tech-wagon can be arranged to perform double-duty: that is to say, with the addition of the spear, the single bale-lifter now combines both a cradle-type bale-lifter and a spear-type bale-lifter.

The cradle-type bale lifter will not do for the task of bagging the first and last netted-bales. The spear-type bale-lifter will not do for the task of collecting and depositing a batch of bales onto the wagon, without stopping. The combination of the two, in a single bale-lifter, provides an economical and very efficient unit. The combination is aimed at enabling the overall task of collecting netted-bales from a field, and encasing all those bales in a long airtight sausage, to be completed using a minimum of resources, including time.

FIGS. 1,2,3 show a bale-lifting spear 23 which, in its deployed position, is pointing forwards, with respect to the direction of motion 29 of the tech-wagon. The spear 23 is carried on a spear-mounting 50. The bale-cradle 25 includes an inner-arm 52, an outer-arm 54, and a crossbar 56. The outer-arm 54 includes a stiffening-plate 58, and the spear-mounting 50 is bolted to the stiffening-plate 58.

The spear 23 is pivotable with respect to the spear-mounting 50, about a pivot pin 60. The spear is locked into its deployed position, pointing forwards (being the position shown in FIGS. 1,2,3), by means of a locking peg 61. Thus, the wagon-driver drives the tech-wagon 20 forwards, in order to drive the spear into a haybale resting on the ground.

The spear 23 can also be locked, by the peg 61, in its stowed (safe) position, in which the spear is pointing backwards.

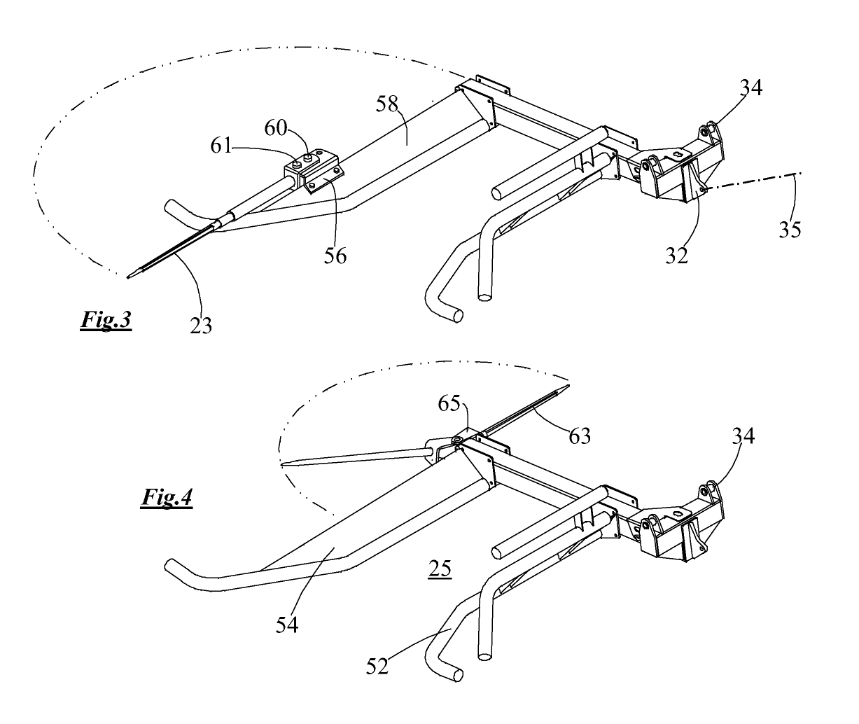

FIGS. 4,5 show another bale-lifting spear 63. The spear-mounting 65 is a bracket that is attached to the end of the crossbar 56. In its deployed position, the spear 63 is now pointing backwards. Thus, the wagon-driver now drives the tech-wagon 20 backwards in order to drive the spear into a haybale resting on the ground. In its stowed position, the spear points forwards. Again, in FIGS. 4,5, the spear 63 can be locked, in either of its positions.

In yet another bale-lifting spear (not shown), the spear-mounting is a bracket that is attached partway along the cross-bar 56. In its deployed position, the spear 63 points backwards. Again, the wagon-driver drives the tech-wagon 20 backwards, in order to drive the spear into a haybale resting on the ground. In its stowed position, the spear points is aligned with the crossbar. Again, the spear can be locked, in either of its positions.

The tech-wagon already includes a cradle-lifter. It has been recognized that, therefore, all that is needed, in order to secure a facility to spear the bale, and to lift the bale by means of the spear, is to provide the actual spear, and to mount the spear on the cradle. The spear can then make use of the lifting function that is already present, in respect of the cradle. This may be contrasted with providing the spear-lifting function (needed for bag-placement) by providing a separate spear-equipped front-end-loader, with driver.

The introduction of the tech-wagon implement, with its cradle-lifter, enabled an enormous reduction in the resources needed to collect hay-bales from a field, and place them on the deck of the bale-wrapping machine. The task of collecting-and-wrapping the bales can now be accomplished so speedily that even a minor delay or interruption can have a large impact on that speed and efficiency. The provision of a spear actually mounted on the cradle, in fact enables the actual realization of the huge efficiencies that were made theoretically possible by the introduction of the tech-wagon.

Using the technology as described herein, the operation of bagging the two end bales takes a minute or two; using a dedicated bale-spear machine or attachment, on a real farm, the same operation used to take an hour or more. When the whole job of collecting and wrapping a hundred bales used to take several operators and drivers the best part of a day, the extra time spent spiking and bagging the end-bales was hardly noticeable, and taking steps to reduce that time was hardly worthwhile. But if the whole job of collecting and wrapping a hundred bales takes barely an hour, but for the spiking operation, which could take an additional hour, saving time on the spiking operation now becomes very worthwhile.

Putting the spear on the tech-wagon, and in particular on the lifting cradle of the tech-wagon, means that the machinery for actually raising or lifting the speared bale is provided effectively for nothing, in that the machinery (and its operator) is already provided for lifting the cradle.

The numerals used in the accompanying drawings may be summarized as:
20 tech-wagon
23 bale-lifting spear
25 bale-cradle
27 platform of tech-wagon
28 direction of motion of tech-wagon
29 bale-lifter
30 lead-in deflector, of outer arm of cradle
32 bracket, component of bale-lifter
34 cradle-pivot
35 hydraulic ram of cradle lifter
38 bale-pusher, operable to push bales to back of platform 27
40 spear-end-face of haybale
41 netted haybale
43 open-end-face of haybale
50 mounting for spear
52 inner-arm of cradle
54 outer-arm of cradle
56 crossbar of cradle
58 stiffening plate of outer-arm
60 pivot-pin, spear-mounting
61 locking-peg
63 bale-lifting spear (FIGS. 4,5)
65 spear-mounting

The scope of the patent protection sought herein is defined by the accompanying claims. The apparatuses and procedures shown in the accompanying drawings and described herein are examples.

Some of the physical features of the apparatuses depicted herein have been depicted in just one apparatus. That is to say, not all options have been depicted of all the variants. Skilled designers should understand the intent that depicted features can be included or substituted optionally in others of the depicted apparatuses, where that is possible.

Terms of orientation (e.g “up/down”, “left/right”, and the like) when used herein are intended to be construed as follows. The terms being applied to a device, that device is distinguished by the terms of orientation only if there is not one single orientation into which the device, or an image of the device, could be placed, in which the terms could be applied consistently.

Geometrical terms used herein, such as “cylindrical”, “vertical”, and the like, which define respective theoretical constructs, are intended to be construed according to the purposive construction.

1. Apparatus for gathering haybales, wherein:
the apparatus includes a combined haybale-picker and transporter, here termed a tech-wagon;
the tech-wagon includes a platform, which is configured for supporting and transporting haybales;
the tech-wagon includes a bale-cradle, which is so configured as to be capable of picking a haybale up off the ground;
the tech-wagon includes a power-operated cradle-lifter, which is effective, when operated, to raise the bale-cradle, and to lift a haybale in the cradle from the ground, and to convey the haybale onto the platform;
the apparatus includes a bale-lifting-spear;
the apparatus includes a spear-mounting, by which the bale-lifting-spear is mounted on the bale-cradle of the tech-wagon;
the apparatus is so arranged that, in a deployed-position of the bale-lifting-spear, the spear is capable of penetrating into a haybale resting on the ground;
the apparatus is so arranged that, when the bale-lifting-spear is entered into a haybale, and when the cradle-lifter is operated, that haybale is thereby lifted off the ground.

2. As in claim 1, wherein, in respect of haybales being penetrated by the bale-lifting-spear:
a spear-end-face is that face of a haybale that is penetrated by the spear;
an open-end-face is that face of the bale that lies diametrically opposite the spear-end-face of the bale;
the apparatus is so arranged that the cradle-lifter is effective, when operated, to lift a speared haybale off the ground far enough that the open-end-face of the haybale is accessible to be covered by a plastic bag to be placed thereover.

3. As in claim 2, wherein:
the tech-wagon has wheels and is movable forwards or backwards in a direction of motion;
the axis of the spear, in its deployed-position, lies parallel to the direction of motion of the tech-wagon;
whereby the spear can be driven into the spear-end-face of a haybale while the bale is resting on the ground, by moving the tech-wagon in its direction of motion.

4. As in claim 1, wherein:
the spear-mounting includes a spear-pivot;
the spear is rotatable about the spear-pivot, between its deployed-position and a stowed-position.

5. As in claim 4, wherein:
the spear-mounting includes a lock;
the lock is operable to lock the spear in the deployed-position; and
the lock is operable also to lock the spear in the stowed position.

6. As in claim 1, wherein, in its deployed-position, the bale-spear points forwards.

7. As in claim 6, wherein:
the bale-cradle includes an inner-arm, an outer-arm, and a cross-bar;
the spear-mounting is located on the outer-arm.

8. As in claim 1, wherein, in its deployed-position, the bale-spear points rearwards.

9. As in claim 8, wherein:
the bale-cradle includes an inner-arm, an outer-arm, and a cross-bar;
the spear-mounting is located on the cross-bar.

10. As in claim 1, wherein:
the tech-wagon is so structured and configured that:
(a) the cradle-lifter, when operated, moves the cradle between a bale-pick-up or lowered position, and a bale-transfer or raised position;
(b) when the cradle is in its lowered position, and when the tech-wagon is so moved that the cradle approaches and engages a haybale resting on the ground, the cradle gathers and picks up the haybale, whereby the haybale now resides on the cradle, and is moved along with the tech-wagon;
(c) when the haybale has been gathered onto the cradle, the cradle-lifter is operable to raise the cradle;
(d) when the bale-cradle is in its raised position, the haybale is transferred from the cradle to the platform of the tech-wagon.

11. Procedure for raising a haybale off the ground, including:
providing an apparatus having all the features recited in claim 2;
moving the tech-wagon relative to the haybale in such manner that the bale-spear enters a spear-end-face of the haybale;
providing the apparatus in such configuration and dimensions that the bale-spear penetrates a distance PD into the haybale;
where a distance PD is the distance the spear can penetrate into the haybale before the spear-end-face of the haybale makes touching contact with any component or part of the cradle or tech-wagon other than the bale-spear;
wherein the penetration distance PD is of such magnitude as to provide sufficient purchase between the haybale and the bale-spear to ensure that the haybale can be lifted securely and safely;
operating the bale-lifter in such manner as to raise the haybale, now on the bale-spear, off the ground.

12. Procedure for raising a haybale off the ground, wherein:
the haybale has a volume of 1.3 cubic metres or more;
the haybale is so configured that no point inside the haybale is more than a distance HR from the nearest point on the surface of the haybale;
the penetration distance PD is at least the distance HR.

13. Procedure for bagging a haybale resting on the ground, including:
carrying out the procedure of claim 11;
upon the haybale being raised off the ground, placing a plastic bag over the raised haybale, in such manner that the bag enwraps the open-end-face of the haybale, whereby the haybale now becomes a bagged end-bale;
lowering the bagged end-bale to the ground;
moving the tech-wagon relative to the haybale in such manner as to withdraw the bale-spear from the bagged end-bale;
moving the apparatus in such manner that the bagged end-bale is picked up in the bale-cradle;
operating the bale-lifter to lift the bagged end-bale onto the platform.

14. Procedure for creating a haybales sausage that is bagged at both ends, including:
carrying out the procedure of claim 13 in respect of a haybale termed the first bagged end-bale;
collecting a first-batch of haybales, which includes the first bagged end-bale, onto the platform of the tech-wagon;
transporting the first-batch, on the tech-wagon, to a bale-wrapping machine;
transferring the first-batch from the tech-wagon to the bale-wrapping machine; and
wrapping the first-batch, to form a first wrapped-sausage;
then collecting an intermediate-batch of haybales onto the platform of the tech-wagon;
transporting the intermediate-batch, on the tech-wagon, to the bale-wrapping machine;
transferring the intermediate-batch from the tech-wagon to the bale-wrapping machine; and
wrapping the intermediate-batch with the first-batch, to form a continuous first-plus-intermediate wrapped-sausage;
then carrying out the procedure of claim 13 in respect of a haybale termed the last bagged end-bale;
collecting a last-batch of haybales, which includes the last bagged end-bale, onto the platform of the tech-wagon;
transporting the last-batch, on the tech-wagon, to the bale-wrapping machine;
transferring the last-batch from the tech-wagon to the bale-wrapping machine; and
wrapping the last-batch with the intermediate-batch, to form a continuous first-plus-intermediate-plus-last wrapped-sausage.
